(19) United States
(12) Patent Application Publication
(10) Pub. No.: US 2017/0019959 A1
(43) Pub. Date: Jan. 19, 2017

(54) COOKING APPARATUS

(71) Applicant: SAMSUNG ELECTRONICS CO., LTD., Suwon-si (KR)

(72) Inventors: Dong Ho PARK, Suwon-si (KR); Kee Hwan KA, Suwon-si (KR); Hyo Sang LEE, Osan-si (KR); Jeong Su HAN, Suwon-si (KR)

(73) Assignee: SAMSUNG ELECTRONICS CO., LTD., Suwon-si (KR)

(21) Appl. No.: 14/949,457

(22) Filed: Nov. 23, 2015

(30) Foreign Application Priority Data
Jul. 13, 2015 (KR) 10-2015-0099037

(51) Int. Cl. H05B 6/12

(52) U.S. Cl. CPC H05B 6/1263; H05B 6/1209

(57) ABSTRACT

A cooking apparatus includes: a main body; a cooking table; an induction coil configured to emit a magnetic field needed for induction heating of a cooking container; and a temperature measurement unit disposed in an electronic component chamber formed in the main body so as to measure a temperature of the cooking container. The temperature measurement unit includes: a case having an opening formed at a top surface thereof; a temperature sensor disposed in the case so as to measure a temperature of the cooking container; and a cooling duct, one side of which is coupled to the case and the other side of which includes an air inlet therein. The temperature measurement unit is configured to adjust an internal temperature of the case when air introduced from the air inlet moves to the case through the cooling duct.

### CROSS-REFERENCE TO RELATED APPLICATIONS

This application claims the benefit of Korean Patent Application No. 10-2015-0099037, filed on Jul. 13, 2015 in the Korean Intellectual Property Office, the disclosure of which is incorporated herein by reference.

### BACKGROUND

1. Field

Embodiments of the present disclosure relate to a cooking apparatus including a temperature measurement unit having superior temperature measurement performance.

2. Description of Related Art

A cooking apparatus is a home appliance for cooking food using gas or electricity. The cooking apparatus is configured to cook food in various ways, for example, an oven, a microwave oven, an induction heater, etc. An improved cooking device has recently been developed and come onto the market.

The cooking apparatus includes a temperature measurement member configured to measure either an internal temperature of a cooking chamber or a temperature of a cooking container to be heated. The temperature measurement member measures the internal temperature of the cooking chamber or the temperature of the cooking container to be heated, such that it is used to implement automatic control of the cooking apparatus as well as to prevent the occurrence of faulty operation or an unexpected accident, etc. There are various methods for measuring a temperature using the temperature measurement member. In accordance with a representative method from among the methods, a temperature measurement member configured to measure a temperature using an infrared wavelength emitted from a target object to be measured is installed in an induction heater.

In the case of measuring a temperature using infrared light, if a peripheral temperature of the temperature measurement member increases, it may be difficult to accurately measure a temperature of a target object to be measured due to the occurrence of infrared light emitted from the vicinity of the temperature measurement member. In addition, due to high temperature, measurement performance of the temperature measurement member may be deteriorated and a lifespan of the temperature measurement member may be shortened. As a result, various methods for adjusting a temperature of the temperature measurement member have been developed and rapidly come into widespread use.

### SUMMARY

Therefore, it is an aspect of the present disclosure to provide a cooking apparatus having an improved structure so as to more accurately measure a temperature of a target food to be measured.

It is another aspect of the present disclosure to provide a cooking apparatus having an improved structure so as to easily adjust a temperature of a temperature measurement unit.

Additional aspects of the disclosure will be set forth in part in the description which follows and, in part, will be obvious from the description, or may be learned by practice of the disclosure.

In accordance with an aspect of the present disclosure, a cooking apparatus includes: a main body; a cooking table disposed over the main body so as to support a cooking container; an induction coil configured to emit a magnetic field needed for induction heating of the cooking container; and a temperature measurement unit disposed in an electronic component chamber formed in the main body so as to measure a temperature of the cooking container. The temperature measurement unit may include: a case having an opening formed at a top surface thereof; a temperature sensor disposed in the case so as to measure a temperature of the cooking container using infrared light emitted from the cooking container; and a cooling duct, one side of which is coupled to the case and the other side of which includes an air inlet therein. The temperature measurement unit may be configured to adjust an internal temperature of the case when air introduced from the air inlet moves to the case through the cooling duct.

In accordance with another aspect of the present disclosure, the air inlet may be spaced apart from the induction coil by a predetermined distance.

The air inlet may be formed at the bottom surface of the cooling duct, and may be spaced apart from the bottom surface of the electronic component chamber by a predetermined distance.

At least some parts of the case may be arranged to face the cooking container.

The temperature measurement unit may further include: a blowing fan disposed in the cooling duct so as to blow air toward the case.

The temperature measurement unit may further include: a filter disposed between the opening and the temperature sensor so as to filter out a noise wavelength.

The case may include: a first case; and a second case disposed in the first case and spaced apart from an inner surface of the first case by a predetermined distance.

The temperature sensor may be disposed in the second case.

A cooling passage may be formed between the first case and the second case.

The opening may be used as an outlet of the air introduced into the case through the cooling duct.

In accordance with another aspect of the present disclosure, a cooking apparatus including a temperature measurement unit configured to measure a temperature of a cooking container includes: a case having an opening formed at a top surface thereof; a temperature sensor disposed in the case so as to measure a temperature of the cooking container using infrared light emitted from the cooking container; a cooling duct, one side of which is coupled to the case and the other side of which includes an air inlet therein; a cooling passage configured to couple the air inlet to the opening; and a blowing fan disposed in the cooling passage so as to blow air toward the air inlet, wherein the air introduced from the air inlet moves to the opening through the cooling passage so as to adjust a temperature of the case and a temperature of the temperature sensor.

The temperature measurement unit may be located in an electronic component chamber provided in a main body of the cooking apparatus; and at least some parts of the case may be disposed to face the cooking container.

The air inlet may be formed at the bottom surface of the cooling duct, and may be spaced apart from the bottom surface of the electronic component chamber by a predetermined distance.

The temperature measurement unit may further include: a filter disposed between the opening and the temperature sensor so as to filter out a noise wavelength.

The case may include: a first case; and a second case disposed in the first case and spaced apart from an inner surface of the first case by a predetermined distance.

The cooling passage may include a space between the first case and the second case.

The temperature sensor may be disposed in the second case.

In accordance with another aspect of the present disclosure, a cooking apparatus includes: a main body; a cooking table disposed over the main body so as to support a cooking container; an induction coil configured to emit a magnetic field needed for induction heating of the cooking container; and a temperature measurement unit disposed in an electronic component chamber formed in the main body so as to measure a temperature of the cooking container. The temperature measurement unit may include: a case having an opening formed at a top surface thereof; a temperature sensor disposed in the case so as to measure a temperature of the cooking container using infrared light emitted from the cooking container; and a cooling duct, one side of which is coupled to the case and the other side of which includes an air inlet therein. The opening may receive the infrared light so that air introduced from the cooling duct cools the case and the temperature sensor and the opening is used as a discharge passage of the air.

The case may include a first case, and a second case disposed in the first case and spaced apart from an inner surface of the first case by a predetermined distance. The temperature sensor may be disposed in the second case.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating the appearance of a cooking apparatus.

FIG. 2 is an exploded perspective view illustrating a structure of an induction heating cooking device of the cooking apparatus shown in FIG. 1.

FIG. 3 is an enlarged perspective view illustrating a structure of the induction heating cooking device shown in FIG. 2.

FIG. 4 is a top view illustrating the induction heating cooking device shown in FIG. 3.

FIG. 5 is a cross-sectional view illustrating that a temperature measurement unit is installed in the induction heating cooking device of FIG. 3 according to an embodiment of the present disclosure.

FIG. 6 is a perspective view illustrating an enlarged view of the temperature measurement unit installed in the induction heating cooking device shown in FIG. 5.

FIG. 7 is an exploded perspective view illustrating a temperature measurement unit contained in the temperature measurement unit shown in FIG. 6.

FIG. 8 is a cross-sectional view illustrating the temperature measurement unit taken along the line B-B′ of FIG. 7.

FIG. 9 is a view illustrating air flow for adjusting a temperature of the temperature measurement unit shown in FIG. 5.

FIG. 10 is a cross-sectional view illustrating the temperature measurement unit according to another embodiment of the present disclosure.

FIG. 11 is a view illustrating air flow for adjusting a temperature of the temperature measurement unit shown in FIG. 10 installed in the cooking apparatus.

### DESCRIPTION OF EMBODIMENTS

Reference will now be made in detail to the embodiments of the present disclosure, examples of which are illustrated in the accompanying drawings, wherein like reference numerals refer to like elements throughout.

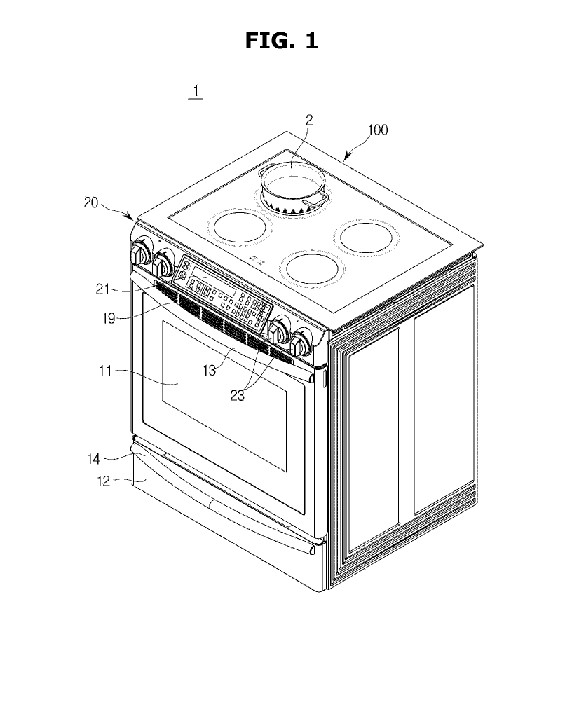

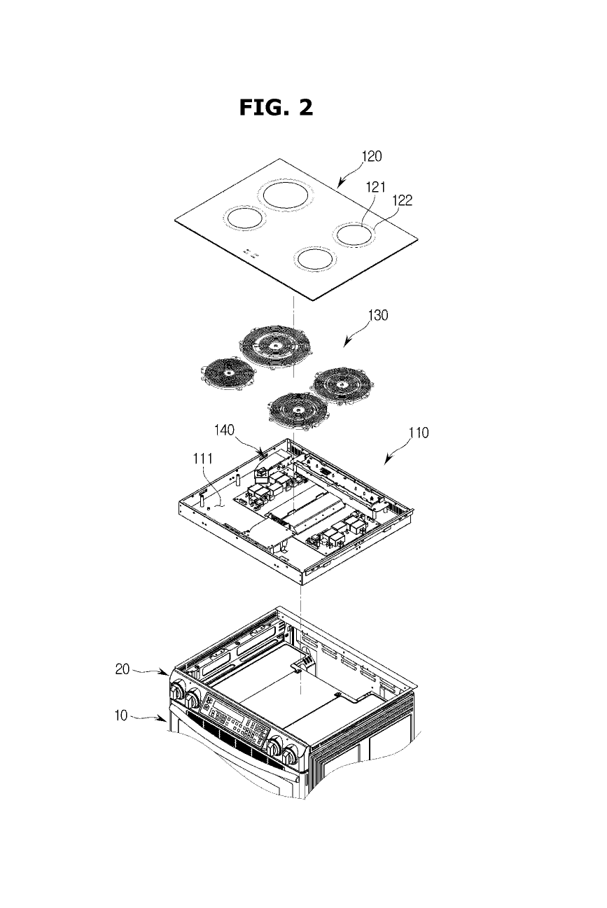

FIG. 1 is a perspective view illustrating the appearance of a cooking apparatus. FIG. 2 is an exploded perspective view illustrating a structure of an induction heating cooking device of the cooking apparatus shown in FIG. 1.

Referring to FIGS. 1 and 2, the cooking apparatus 1 according to an embodiment of the present disclosure may include an oven 10 disposed at a lower part, and an induction heating cooking device 100 disposed at an upper part. The oven 10 and the induction heating cooking device 100 may be incorporated with each other. The induction heating cooking device 100 according to the embodiment may be incorporated with the oven 10 as described above, or may also be arranged independently of the oven 10 as necessary. For convenience of description and better understanding of the present disclosure, the cooking apparatus 1 in which the oven 10 and the induction heating cooking device 100 are incorporated with each other will hereinafter be described as an example.

The oven 10 may emit a high-temperature heat using gas or electricity, and may cook food located in the cooking chamber through convection. Doors (11, 12) configured to open or close the cooking chamber may be arranged at the front surface of the cooking apparatus 1. Handles (13, 14) may be respectively formed at the doors (11, 12) so that the user can grasp the handles (13, 14).

A control panel 20 configured to display operation states of the oven 10 or the induction heating cooking device 100 may be arranged at upper ends of the doors (11, 12). The control panel 20 may include a display unit 21 to display various operation information of the oven 1, and a manipulation unit 23 to manipulate operations of the oven 1.

An air inlet 19 may be formed at one side of the front surface of the cooking apparatus 1. The air inlet 19 may be disposed between the oven 10 and the control panel 20.

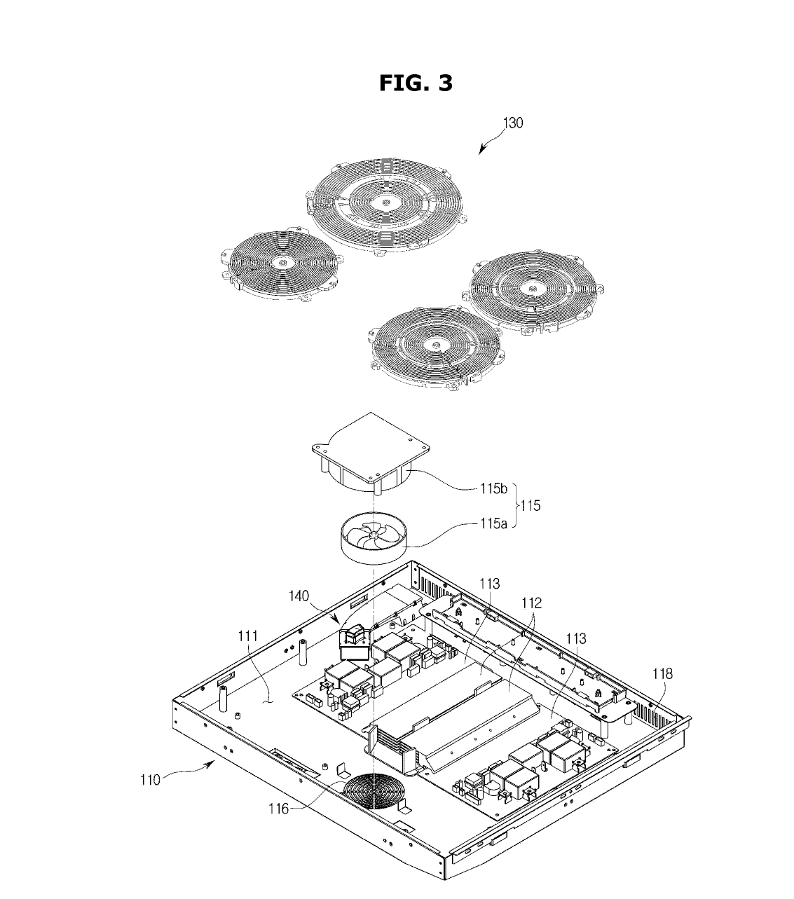

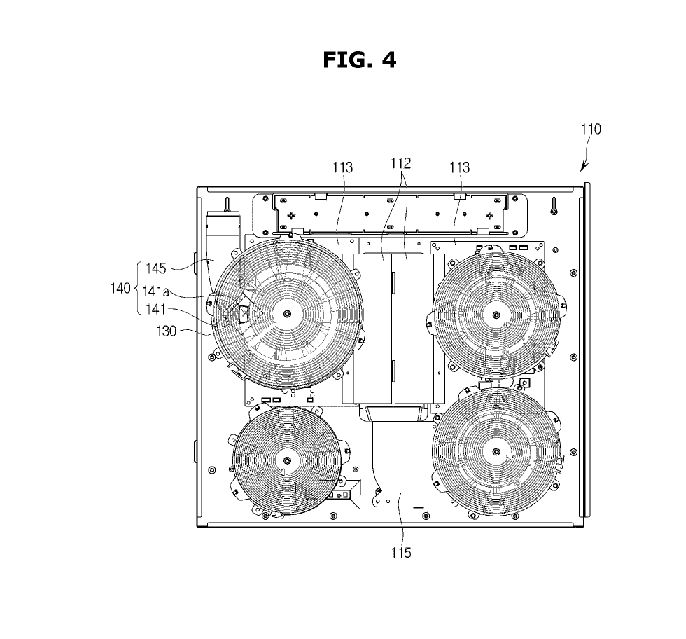

FIG. 3 is an enlarged perspective view illustrating a structure of the induction heating cooking device shown in FIG. 2. FIG. 4 is a top view illustrating the induction heating cooking device shown in FIG. 3.

Referring to FIGS. 2 to 4, the induction heating cooking apparatus 100 may be disposed over the oven 10. The induction heating cooking device 100 may include a main body 110 to form the external appearance thereof; a cooking table 120 provided at the top surface of the main body 110 so that a cooking container 2 is disposed thereon; an induction coil 130 to inductively heat the cooking container 2; and a temperature measurement unit 140 to measure a temperature of the cooking container 2.

The main body 110 may form the external appearance of the induction heating cooking device 100. The main body 110 may be inserted into the external case of the cooking apparatus 1. The main body 110 may have a box shape, the top of which is open. The cooking table 120 may be coupled to the opened top surface of the main body 110, and may include an electronic component chamber 111 therein.

The electronic component chamber 111 may include at least one electronic component 113 including a main board and the like; a heat sink plate 112 configured to cool the electronic component 113; and an electronic-component-chamber blowing fan 115 configured to circulate the internal air of the electronic component chamber 111 toward the outside thereof. The electronic-component-chamber blowing fan 115 may include a fan 115a and a fan cover 115b. The electronic-component-chamber blowing fan 115 may be coupled to the electronic-component-chamber air inlet 116 formed at one side of the main body 110, so that external air can be introduced into the electronic component chamber 111. The electronic-component-chamber air outlet 118 may be formed at one side of the rear part of the main body 110. The air introduced into the electronic component chamber 111 through the electronic-component-chamber blowing fan 115 may exchange heat with the electronic component 113 and the heat sink plate 112, and may then move to the outside through the electronic-component-chamber air inlet 118.

The cooking table 120 may be coupled to the open top surface of the main body 110. The cooking table 120 may be formed of tempered heat-resistant glass (not shown) formed in a flat panel shape on which the cooking container 2 can be disposed; a light interruption film (not shown) disposed at the bottom surface of the tempered heat-resistant glass (not shown), or an upper film (not shown) disposed over the tempered heat-resistant glass. Some parts of the cooking table 120 may be formed of a transparent material. The cooking table 120 may include container guide lines (121, 122) configured to guide positioning of the cooking container 2.

The induction coil 130 may be horizontally arranged at a lower part of the cooking table 120. The induction coil 130 may be spaced apart from the bottom surface of the cooking table 120 by a predetermined distance. The induction coil 130 may be located to face the container guide lines (121, 122). A plurality of induction coils 130 may be used, and may also have different sizes.

Although the induction coil 130 of the embodiment is formed approximately in a circular shape for convenience of description, the scope or spirit of the present disclosure is not limited thereto, and the induction coil 130 may also be formed in a square shape or in various other shapes as necessary.

If current is applied to the induction coil 130, the induction coil 130 may form a magnetic field in a vertical direction. A secondary current may be induced to the cooking container 2 disposed over the cooking table 120 due to the occurrence of the magnetic field, and heat may occur due to the occurrence of resistance components of the cooking container 2. Accordingly, the cooking container 2 may be heated, and food stored in the cooking container may be heated and cooked. The cooking container 2 may contain iron or be magnetic.

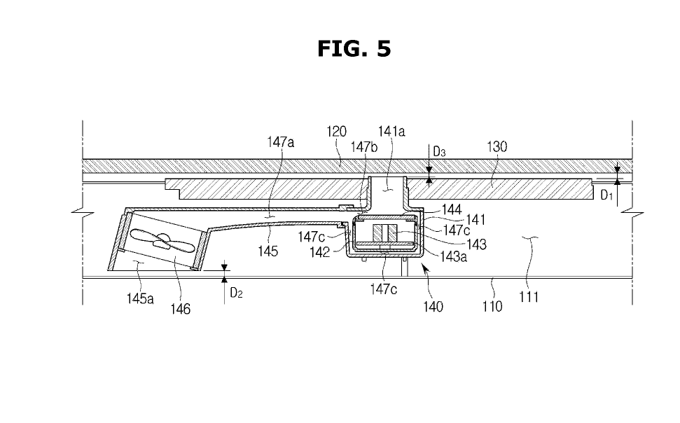

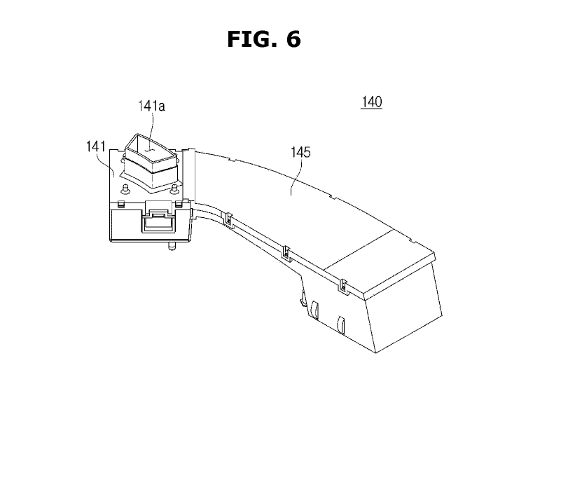

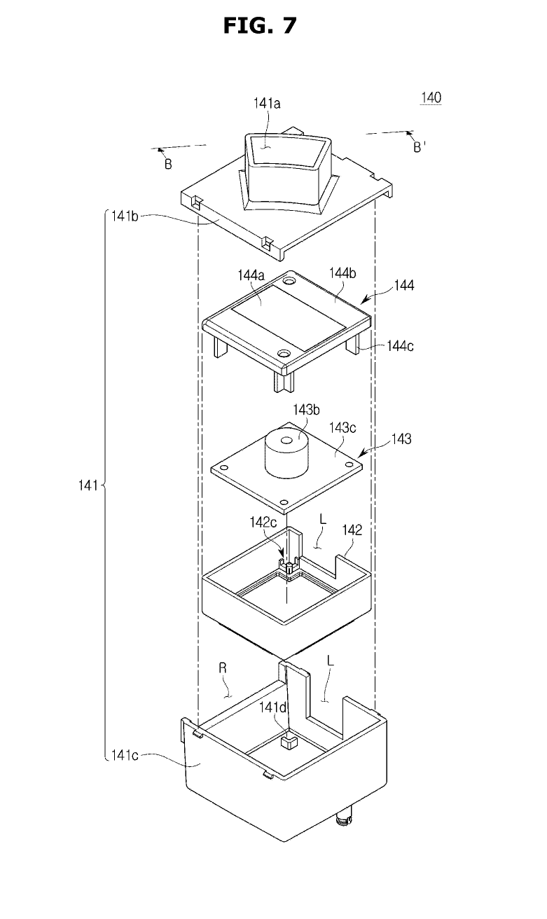

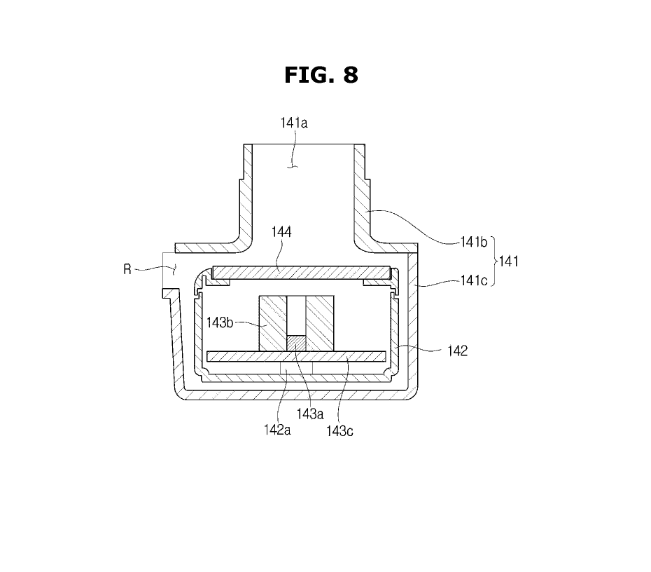

FIG. 5 is a cross-sectional view illustrating that a temperature measurement unit is installed in the induction heating cooking device of FIG. 3 according to an embodiment of the present disclosure. FIG. 6 is a perspective view illustrating an enlarged view of the temperature measurement unit installed in the induction heating cooking device shown in FIG. 5. FIG. 7 is an exploded perspective view illustrating a temperature measurement unit contained in the temperature measurement unit shown in FIG. 6. FIG. 8 is a cross-sectional view illustrating the temperature measurement unit taken along the line B-B′ of FIG. 7.

Referring to FIGS. 2 to 8, the temperature measurement unit 140 may be installed in the electronic component chamber 111 so as to measure a temperature of the cooking container 2. The temperature measurement unit 140 may include temperature measurement units (141, 142, 143, 144) configured to measure a temperature of the cooking container 2; and a cooling unit including both a cooling duct 145 and a blowing fan 146 so as to adjust a temperature of the temperature measurement units (141, 142, 143, 144).

The temperature measurement unit 140 may include cases (141, 142), a temperature sensor 143, and a cooling duct 145.

The cases (141, 142) may form the external surfaces of the temperature measurement units (141, 142, 143, 144). Each of the cases (141, 142) may include a temperature sensor 143 therein.

The opening 141a may be formed at the top surface of each case (141, 142). The opening 141a may be used as an air-inlet passage through which infrared light emitted from the cooking container 2 is received. In addition, the opening 141a may also be used as an air outlet through which the air received through the cooling duct 145 is discharged.

Some parts of the temperature measurement unit 140 may be arranged to face the cooking container 2. Some parts of the opening 141a may be arranged to face the cooking container 2. Referring to FIGS. 4 and 5, the opening 141a may be located in the induction coil 130 from a top view. In addition, the opening 141a may be spaced apart from the cooking table 120 by a third distance D3. The induction coil 130 may be spaced apart from the cooking table 120 by a first distance D1, and a third distance D3 may be shorter than the first distance D1. For example, the first distance D1 may be set to 5˜7 mm, and the third distance D3 may be set to 3˜5 mm. The spacing between the first distance D1 and the third distance D3 may be changed according to a volume of the electronic component chamber 111.

The cases (141, 142) may include a first case 141 and a second case 142 disposed in the first case 141.

The opening 141a may be formed at the top surface of the first case 141. The first case 141 may include a lower case 141c, the top of which is open, and a top cover 141b coupled to the top surface of the lower case 141c. The opening 141a may be provided at the top cover 141b.

The second case 142 may be spaced apart from the inner lateral surface of the first case 141 by a predetermined distance. A separation member 141d may be formed at the inner lateral surface of the first case 141. The separation member 141d may support the second case 142. The second case 142 may be spaced apart from the inner lateral surface of the first case 141 by a predetermined distance.

The second case 142 may have an opened top surface. The temperature sensor 143 may be disposed in the second case 142. A filter 144 to be described later may be coupled to the opened top surface of the second case 142.

An airflow-passage hole R may be formed at one side of the first case 141 in such a manner that the air received from the cooling duct 145 may be introduced into the temperature measurement units (141, 142, 143, 144).

A communication-line hole L may be formed at the side surfaces of the first case 141 and the second case 142 such that a communication line between the temperature sensor 143 and the controller (not shown) can be installed through the hole L. In this case, the controller may control the output of the induction coil 130 according to a detection signal of the temperature sensor 143.

The communication-line hole L and the airflow-passage hole R formed in the first case 141 may be formed at the same or different side surfaces.

The temperature sensor 143 may be disposed in the cases (141, 142). The temperature sensor 143 may be disposed in the second case 142. The support member 142a may be formed at the inner lateral surface of the second case 142 so as to support the temperature sensor 143.

The temperature sensor 143 may include a circuit board 143c; a sensor 143a disposed over the circuit board 143c; and a protection unit 143b enclosing the sensor 143a so as to protect the sensor 143a. The protection unit 143b may be formed in a manner that the top part of the sensor 143a is open so that infrared light can easily move to the sensor 143a. The temperature sensor 143 may be an infrared sensor capable of sensing an infrared wavelength.

The temperature measurement unit 140 may further include the filter 144. The filter 144 may filter out a noise wavelength other than the infrared wavelength from all wavelengths shifted to the temperature sensor 143. The filter 144 may be disposed between the temperature sensor 143 and the opening 141a. The filter 144 may be coupled to the top surface of the second case 142 at an upper part of the temperature sensor 143.

The filter 144 may include a frame 144b; a filter unit 144a located to face the temperature sensor 143 at the inside of the frame 144b; and a separation unit 144c configured to separate the frame 144b and the filter unit 144a from the temperature sensor 143. The separation unit 144c may be installed at the bottom surface of the frame 144b.

The cooling duct 145 may serve as a passage through which the air moves to the temperature sensor 143 and the cases (141, 142). The case 141 may be coupled to one side of the cooling duct 14, and the air inlet 145a may be formed at the other side of the cooling duct 14. The cooling duct 145 may be coupled to the airflow-passage hole R formed in the first case 141.

The air inlet 145a may be spaced apart from the induction coil 130 by a predetermined distance. The air inlet 145a may be spaced apart from the heat sink plate 112 disposed in the electronic component chamber 111 by a predetermined distance, and may also be spaced apart from the electronic components (112, 113) including the main board by a predetermined distance. Accordingly, the air inlet 145a may be spaced apart from various heating components, for example, the heat sink plate 112, the electronic components (112, 113), the induction coil 130, etc. by a predetermined distance at the inside of the electronic component chamber 111, such that air can be introduced through the air inlet 145a. As a result, relatively-low-temperature air may be introduced into the electronic component chamber 111.

The air inlet 145a may be provided at the bottom surface of the cooling duct 145. The air inlet 145a may be spaced apart from the bottom surface of the electronic component chamber 111 by the second distance D2. The second space D2 may be set to 5˜7 mm. The internal air of the electronic component chamber 111 may be introduced into the cooling duct 145 through the air inlet 145a due to the second distance D2. As a result, the air located in the lower part of the electronic component chamber 111 is introduced into the cooling duct 145, such that the relatively-low-temperature air may be introduced into the electronic component chamber 111.

As described above, the cooling duct 145 may be extended from the cases (141, 142) in such a manner that the air inlet 145a can be spaced apart from the heating components by a predetermined distance. Referring to FIG. 6, the cooling duct 145 may be bent in one direction. In contrast, the cooling duct 145 may be extended in a straight line. The shape of the cooling duct 145 may be changed according to the positions of electronic components installed in the electronic component chamber 111.

The blowing fan 146 may be installed in the cooling duct 145. The blowing fan 146 may allow the air from the electronic component chamber 111 to move to the cooling duct 145. In addition, the blowing fan 146 may be configured in a manner that the internal air of the cooling duct 145 can move to the cases (141, 142).

Referring to FIG. 5, the temperature measurement unit 140 may include the cooling passages (147a, 147b, 147c) through which the air flows in a manner that the temperature of the temperature measurement unit 40 can be adjusted. The cooling passages (147a, 147b, 147c) may include a first cooling passage 147a extended from the air inlet 145a to the first case 141; a second cooling passage 147b extended from the inside of the first case 141 to the opening 141a along the upper part of the second case 142; and a third cooling passage 147c extended from the inside of the first case 141 to the opening 141a along the lateral and bottom surfaces of the second case 142. The second cooling passage 147b and the third cooling passage 147c may be formed in the spacing between the first case 141 and the second case 142.

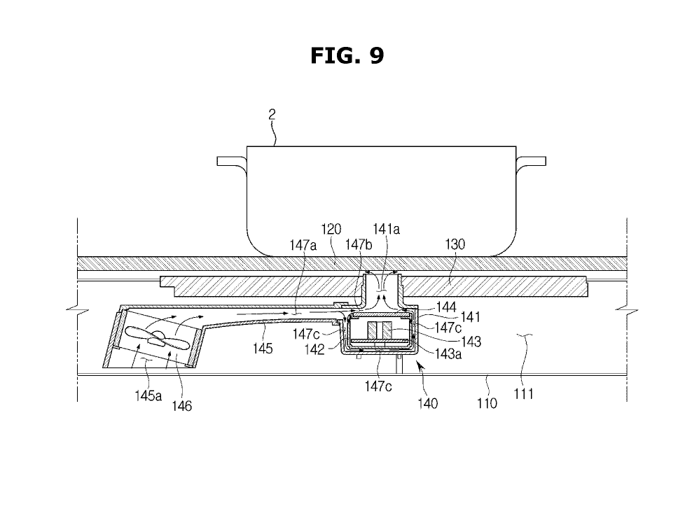

FIG. 9 is a view illustrating air flow for adjusting a temperature of the temperature measurement unit shown in FIG. 5.

Referring to FIG. 9, the air introduced from the air inlet 146a may move to the opening 141a along the cooling passages (147a, 147b, 147c), and at the same time may cool the temperature measurement unit 140. Since the air moves to lateral-, bottom-, and top-surfaces of the second case 142 through the second cooling passage 147b and the third cooling passage 147c, the first case 141, the second case 142, the temperature sensor 143, and the filter 144 may be cooled. The air inlet 146a may be arranged at a specific position where the heating component is not present in the electronic component chamber 111, and may be formed at the bottom of the cooling duct 145 so that lower-temperature air moves to the cooling passages (147a, 147b, 147c), resulting in increased cooling efficiency. Additional cooling passages (147a, 147b, 147c) may be formed in the electronic component chamber 111 so that the cooling efficiency of the temperature measurement unit 140 can be improved.

As a result, the temperature measurement unit 140 may be maintained at an appropriate temperature. In addition, the temperature measurement unit 140 is prevented from being overheated so as to reduce a noise wavelength emitted from peripheral part, such that improved measurement performance can be guaranteed. In addition, since the temperature measurement unit 140 is prevented from being overheated, the occurrence of malfunction of a manufactured product can be prevented, resulting in increased lifespan of the temperature measurement unit 140.

The temperature measurement unit 150 according to another embodiment of the present disclosure will hereinafter be described in detail.

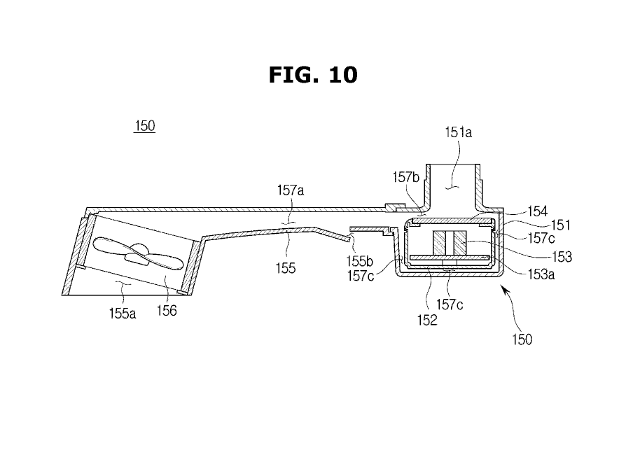

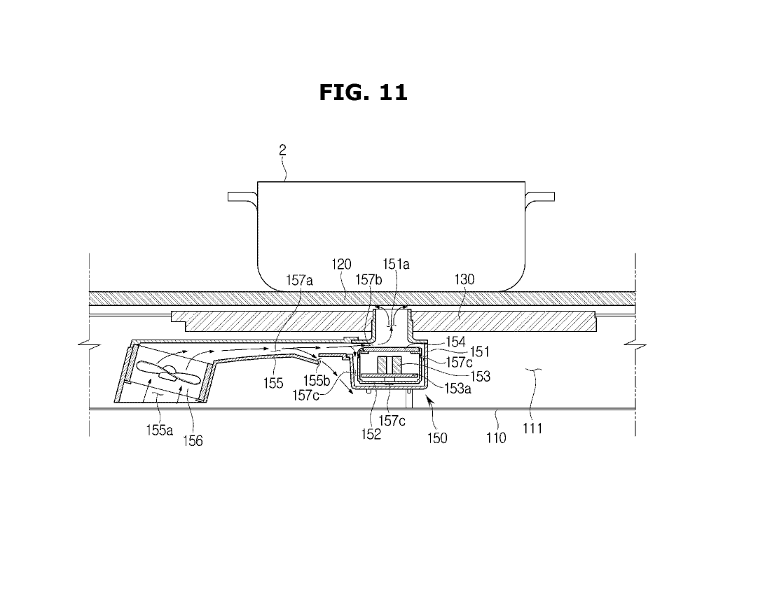

FIG. 10 is a cross-sectional view illustrating the temperature measurement unit according to another embodiment of the present disclosure. FIG. 11 is a view illustrating air flow for adjusting a temperature of the temperature measurement unit shown in FIG. 10 installed in the cooking apparatus.

Referring to FIG. 10, the temperature measurement unit 150 may include the temperature measurement units (151, 152, 153, 154) consisting of a first case 151, a second case 152, a temperature sensor 153, and a filter 154; and a cooling unit including the cooling duct 155 and the blowing fan 156 so as to adjust a temperature of the temperature measurement units (151, 152, 153, 154). The temperature measurement unit 150 may include the cooling passages (157a, 157b, 157c) through which the air can move from the air inlet 155a to the opening 151a.

The temperature measurement unit 150 shown in FIG. 10 may be different in structure from the cooling duct 155 as compared to the temperature measurement units 140 shown in FIGS. 5 to 9, and the remaining constituent components may be identical to those of FIGS. 5 to 9. For convenience of description and better understanding of the present disclosure, detailed description of the same constituent components as those of FIGS. 5 to 9 will herein be omitted, and only different components will be described below.

One side of the cooling duct 155 may be coupled to the first case 151, and the air inlet 155a may be formed in the other side of the cooling duct 155. As a result, air introduced from the air inlet 155a may flow into the first case 151.

The cooling duct 155 may further include a lower discharge unit 155b. The lower discharge unit 155b may be formed in a manner that some parts of the air flowing into the first case 151 can be discharged to the outside of the cooling duct 155. The air discharged from the lower discharge unit 155b may contact the lower part of the first case 151. As a result, the air discharged from the lower discharge unit 155b may contact the lower part of the first case 151 so that the external surface of the first case 151 can be cooled. The temperature measurement unit 150 may simultaneously cool not only the inner part of the first case 151 but also the outer part thereof, resulting in increased cooling efficiency.

As is apparent from the above description, the embodiments of the present disclosure can provide a cooking apparatus including a temperature measurement unit having improved temperature measurement performance.

The embodiments of the present disclosure can prevent a temperature of the temperature measurement unit from increasing, and can correctly measure a temperature of a target object to be measured.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A cooking apparatus comprising:
a main body having an electronic component chamber formed therein;
a cooking table disposed over the main body to support a cooking container;
an induction coil configured to emit a magnetic field to heat the cooking container by induction heating; and
a temperature measurement unit disposed in the electronic component chamber to measure a temperature of the cooking container, the temperature measurement unit including
a case having an opening formed at a top surface thereof,
a temperature sensor disposed in the case to measure a temperature of the cooking container based on infrared light emitted from the cooking container, and
a cooling duct having one side coupled to the case and another side including an air inlet therein,
the temperature measurement unit being configured to adjust an internal temperature of the case when air introduced from the air inlet moves to the case through the cooling duct.

2. The cooking apparatus according to claim 1, wherein the air inlet is spaced apart from the induction coil by a predetermined distance.

3. The cooking apparatus according to claim 1, wherein the air inlet is formed at a bottom surface of the cooling duct, and is spaced apart from a bottom surface of the electronic component chamber by a predetermined distance.

4. The cooking apparatus according to claim 1, wherein at least a portion of the case is arranged to face the cooking container.

5. The cooking apparatus according to claim 1, wherein the temperature measurement unit further includes:
a blowing fan disposed in the cooling duct to blow air toward the case.

6. The cooking apparatus according to claim 1, wherein the temperature measurement unit further includes:
a filter disposed between the opening and the temperature sensor to filter out a noise wavelength.

7. The cooking apparatus according to claim 1, wherein the case includes:
a first case; and
a second case disposed in the first case and spaced apart from an inner surface of the first case by a predetermined distance.

8. The cooking apparatus according to claim 7, wherein the temperature sensor is disposed in the second case.

9. The cooking apparatus according to claim 7, wherein a cooling passage is formed between the first case and the second case.

10. The cooking apparatus according to claim 1, wherein the opening is used as an outlet of the air introduced into the case through the cooling duct.

11. A cooking apparatus including a temperature measurement unit configured to measure a temperature of a cooking container when the cooking container is used with the cooking apparatus, the temperature measurement unit comprising:
a case having an opening formed at a top surface thereof;
a temperature sensor disposed in the case so as to measure a temperature of the cooking container based on infrared light emitted from the cooking container;
a cooling duct having one side coupled to the case and another side having an air inlet therein;
a cooling passage, defined by the duct and the case, extending between the air inlet and the opening; and
a blowing fan disposed in the cooling passage to blow air introduced from the air inlet toward the opening,
wherein the air introduced from the air inlet moves to the opening through the cooling passage so as to adjust a temperature of the case and a temperature of the temperature sensor.

12. The cooking apparatus according to claim 11, wherein:
the temperature measurement unit is located in an electronic component chamber provided in a main body of the cooking apparatus; and
at least a portion of the case is disposed to face the cooking container.

13. The cooking apparatus according to claim 12, wherein the air inlet is formed at a bottom surface of the cooling duct, and is spaced apart from a bottom surface of the electronic component chamber by a predetermined distance.

14. The cooking apparatus according to claim 11, wherein the temperature measurement unit further includes:
a filter disposed between the opening and the temperature sensor so as to filter out a noise wavelength.

15. The cooking apparatus according to claim 11, wherein the case includes:
a first case; and
a second case disposed in the first case and spaced apart from an inner surface of the first case by a predetermined distance.

16. The cooking apparatus according to claim 15, wherein the cooling passage includes a space between the first case and the second case.

17. The cooking apparatus according to claim 15, wherein the temperature sensor is disposed in the second case.

18. A cooking apparatus comprising:
a main body having an electronic component chamber formed therein;
a cooking table disposed over the main body so as to support a cooking container;
an induction coil configured to emit a magnetic field needed for induction heating of the cooking container; and
a temperature measurement unit disposed in the electronic component chamber to measure a temperature of the cooking container, the temperature measurement unit including
a case having an opening formed at a top surface thereof;
a temperature sensor disposed in the case to measure a temperature of the cooking container using infrared light emitted from the cooking container and received through the opening; and
a cooling duct having one side coupled to the case and another side having an air inlet therein,
the temperature measurement unit configured such that air introduced from the cooling duct cools the case and the temperature sensor, and is discharged out of the opening.

19. The cooking apparatus according to claim 18, wherein:
the case includes a first case, and a second case disposed in the first case and spaced apart from an inner surface of the first case by a predetermined distance; and
the temperature sensor is disposed in the second case.

20. A cooking apparatus comprising:
a cooking table;
an induction coil disposed under the cooking table and configured to heat a cooking container supported on the cooking table by induction heating; and
a temperature measurement unit disposed under the cooking table and including
a cooling duct,
a case having a top opening toward a bottom side of the cooking table and a second opening connected to cooling duct, such that an interior space of the case is in communication with an airflow passage of the cooling duct,
a temperature sensor disposed in an interior space of the case and configured to measure the temperature of the cooking container, and
a blowing fan to circulate air into and out of the interior space of the case to thereby adjust a temperature of the interior space.

21. The cooking apparatus according to claim 20, wherein:
the case includes a first case, and a second case disposed in the interior space of the first case and spaced apart from an inner surface of the first case by a predetermined distance; and
the temperature sensor is disposed in the second case.

22. The cooking apparatus according to claim 21, wherein:
a bottom outer surface of the second case is spaced apart from a bottom inner surface of the first case, to form a first section of a cooling passage within the first case,
a first lateral outer surface of the second case is spaced apart from an oppositely facing first lateral inner surface of the first case, to form a second section of the cooling passage,
a second lateral outer surface of the second case is spaced apart from an oppositely facing second lateral inner surface of the first case, to form a third section of the cooling passage, and
the airflow passage of the cooling duct is in communication with the first, second, and third sections of the cooling passage within the first case.

23. The cooking apparatus according to claim 21, wherein the cooking table is spaced apart from the induction coil to form an airflow space in between, such that the airflow space is in communication with the interior space of the case through the top opening.
